(19) United States
(12) Patent Application Publication
(10) Pub. No.: US 2013/0250826 A1
(43) Pub. Date: Sep. 26, 2013

(54) COMMUNICATIONS TERMINAL AND COMPUTER READABLE MEDIUM

(71) Applicants: Yoshimichi Tanizawa, Kanagawa-ken (JP); Takeshi Ishihara, Kanagawa-ken (JP); Kotaro Ise, Kanagawa-ken (JP)

(72) Inventors: Yoshimichi Tanizawa, Kanagawa-ken (JP); Takeshi Ishihara, Kanagawa-ken (JP); Kotaro Ise, Kanagawa-ken (JP)

(73) Assignee: KABUSHIKI KAISHA TOSHIBA, Tokyo (JP)

(21) Appl. No.: 13/616,349

(22) Filed: Sep. 14, 2012

(30) Foreign Application Priority Data
Mar. 26, 2012 (JP) P2012-069646

(51) Int. Cl. H04W 52/02

(52) U.S. Cl. 370/311

(57) ABSTRACT

An activation instructing portion to instruct an activation instruction to a communications module and a core module, when a receiver portion receives a activation signal, wherein upon reception of an activation instruction while in a halt mode, the core module switches from the halt mode to an operational mode, upon reception of the activation instruction while in a halt mode, the communications module switches from the halt mode to an operational mode, and sends a reception completion signal after switching to the operational mode, and a period of time needed for the communications module to switch to the operational mode after receiving the activation signal is shorter than that of the core module.

### CROSS-REFERENCE TO RELATED APPLICATION

This application is based upon and claims the benefit of priority from Japanese Patent Application No. P2012-069646, filed on Mar. 26, 2012; the entire contents of which are incorporated herein by reference.

### FIELD

Embodiments generally relate to a communications terminal and a computer readable medium storing a communications program.

### BACKGROUND

One of communications systems providing network services usable by a plurality of communications terminals is a remote activation system that requires a terminal (activation-requesting terminal), which is about to use a network service, to send an activation signal to a terminal (activation-target terminal) configured to offer the network service. In the remote activation system, the activation-target terminal not being offering its network service can be kept inactive, and thus the power consumption can be reduced. The activation-requesting terminal uses the network service offered by the activation-target terminal after activating the activation-target terminal.

There has been a conventional technique in which the activation-target terminal sends an activation completion notice to the activation-requesting terminal once the activation is completed. By receiving the notice of the activation completion, the activation-requesting terminal can check the activation completion of the activation-target terminal. Nevertheless, it takes time for the activation-target terminal to complete its activation after receiving the activation signal. For example, it takes 19 seconds for a particular NAS (Network-attached Storage) server to complete its activation after receiving the activation signal. While the activation-target terminal is in the process of activation, the activation-requesting terminal cannot check whether or not the activation signal has arrived at the activation-target terminal rightly.

Notwithstanding, there is a demand that the activation-requesting terminal should check, as soon as possible, whether or not the activation-target terminal has received the activation signal rightly. In a case where the activation-requesting terminal cannot judge whether or not the activation signal has arrived at the activation-target terminal rightly, the activation-requesting terminal is supposed to do things such as retransmission of the activation signal to the activation-target terminal. The retransmission of the activation signal results in an increase in the power consumption of the activation-requesting terminal, and further the remote activation system as a whole. The above mentioned technology is disclosed in Japanese Patent Application Publication No. 2007-19810, and contents of which are hereby incorporated by reference.

### BRIEF DESCRIPTION OF THE DRAWINGS

FIG. 1 is a block diagram showing a remote activation system of an embodiment of the invention.

FIG. 2 is a block diagram showing an activation-target terminal 100 of the remote activation system shown in FIG. 1.

FIG. 3 is a block diagram showing an activation-requesting terminal 200 of the remote activation system shown in FIG. 1.

FIG. 4 is a flowchart showing how the activation-target terminal 100 operates.

FIG. 5 is a flowchart showing how the activation-requesting terminal 200 operates.

FIG. 6 is a diagram showing a flame format of the CTS (Clear To Send).

### DETAILED DESCRIPTION

An aspect of the embodiments aims at making the activation-requesting terminal capable of quickly checking that the activation signal sent from the activation-requesting terminal has been rightly received by the activation-target terminal.

A communications terminal according to an aspect of one embodiment includes: a receiver portion to receive an activation signal from an activation-requesting terminal; a communications module to send a reception completion signal to the activation-requesting terminal; a core module to provide a core function; and an activation instructing portion to instruct an activation instruction to the communications module and the core module, when the receiver portion receives the activation signal.

Upon reception of the activation instruction while in a halt mode, the core module switches from the halt mode to an operational mode. Upon reception of the activation instruction while in a halt mode, the communications module switches from the halt mode to an operational mode, and sends the reception completion signal after switching to the operational mode. A period of time needed for the communications module to switch to the operational mode after receiving the activation signal is shorter than that of the core module.

### Embodiment

Descriptions will be hereinbelow provided for the embodiment of the invention with reference to the drawings. It should be noted that the same portions are each denoted with the same reference numeral throughout the drawing, and the overlapping description will be omitted.

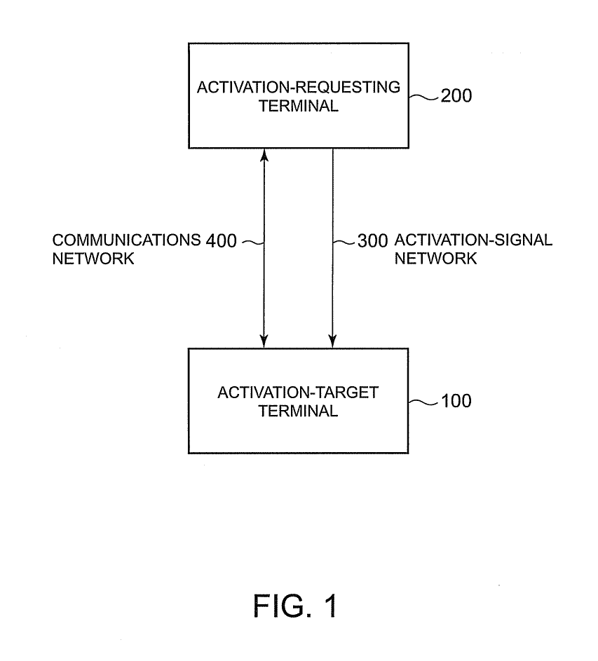

FIG. 1 is a block diagram showing a remote activation system of the embodiment of the invention.

The remote activation system includes: two communications terminals, namely, an activation-requesting terminal 200 and an activation-target terminal 100; and a communications network 400 and an activation-signal network 300 which are communications channels used by the activation-requesting terminal 200 and the activation-target terminal 100.

In the case of a home network system, for example, the activation-target terminal 100 is a terminal for offering a service of delivering video contents, and is an NAS server (Network Attached Storage server), for example. The NAS server is a server holding the video contents. The activation-requesting terminal 200 is one of the terminals of a plurality of users who use the service. For example, the activation-requesting terminal 200 may be a display including a communications function, like a home TV receiver.

Upon receipt of a request for a network service offered by the activation-target terminal 100, the activation-requesting terminal 200 sends an activation signal to the activation-target terminal 100.

The activation-target terminal 100 is suspending the service, while the number of communications terminals using the service is small, for example at night, etc. Even under the halt mode, the activation-target terminal 100 is capable of receiving the activation signal, and is switchable from the halt mode to an operation mode upon reception of the activation signal.

The activation-target terminal 100 put into the operation mode after the activation offers a core network service, for example, the service of delivering a video content, as a response to a service request from the activation-requesting terminal 200.

The activation-signal network 300 shown in FIG. 1 is a network configured to transmit the activation signal sent from the activation-requesting terminal 200 to the activation-target terminal 100. The activation-signal network 300 is, for example, a wireless medium. The activation-signal network 300 may be a wired network, or a wired/wireless-mixed network.

The communications network 400 is a network through which communications terminals, like the activation-requesting terminal 200 and the activation-target terminal 100, exchange data for the network service. The communications network 400 may be of any network type. The communications network 400 is, for example, a wireless medium such as a wireless LAN (Local Area Network). Alternatively, the communications network 400 may be a wired network such as a wired LAN set up using Ethernet (Registered Trade Mark). Otherwise, the communications network 400 may be a network set up by combining a wireless network and a wired network together.

It should be noted that the activation-signal network 300 and the communications network 400 may be formed as mutually different networks, or as a signal network.

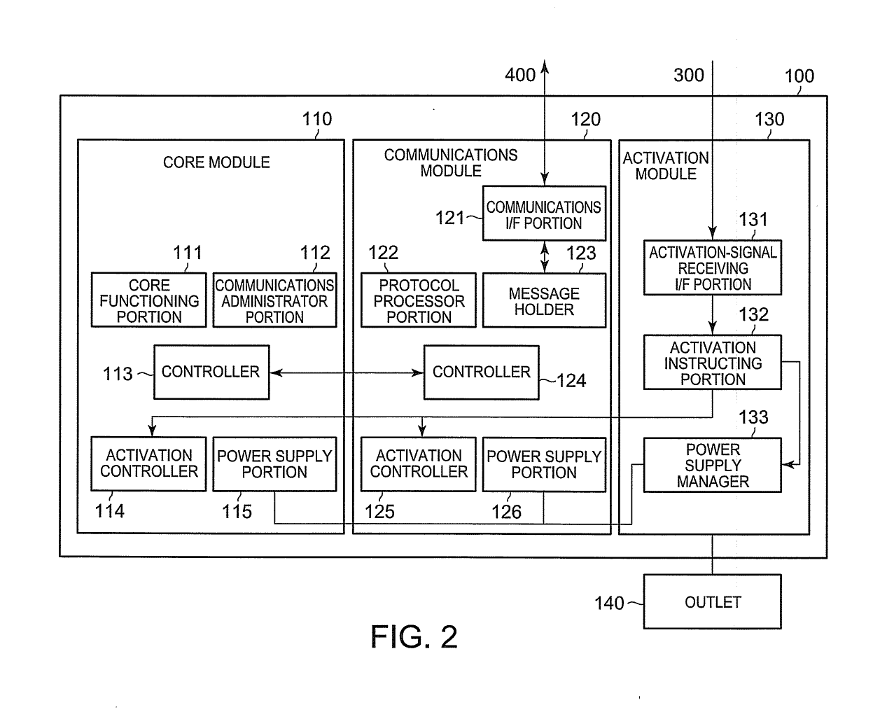

FIG. 2 is a block diagram showing the activation-target terminal 100 in the remote activation system shown in FIG. 1.

To begin with, descriptions will be hereinbelow provided for the outline of the configuration of the activation-target terminal 100.

The activation-target terminal 100 includes: an activation-signal receiving I/F portion 131 configured to receive the activation signal from the activation-requesting terminal 200; a communications module 120 which is switchable between a halt mode and an operational mode; a core module 110 which is switchable between a halt mode and an operational mode; and an activation instructing portion 132 configured to issue an activation instruction to the communications module 120 and the core module 110 once the activation-signal receiving I/F portion 131 receives the activation signal.

In this respect, the activation signal is the one which the activation-target terminal 100 receives from the outside via the activation-signal network 300. The activation signal is a predetermined signal for activating the activation-target terminal 100. To put it more specifically, the activation signal includes an ID for identifying an activation module 130 of the activation-target terminal 100, for example. On the other hand, the activation instruction is a predetermined signal for activating the communications module 120 and the core module 110, and the one sent and received inside the activation-target terminal 100.

The core module 110 provides core functions for the network service offered by the activation-target terminal 100. In the case where, for example, the activation-target terminal 100 is the NAS server, examples of the core functions include: holding the video contents; selecting requested one from the video contents; and responding to controls. The core module 110 offers its network service by use of the network function, which the communications module 120 has, in the form of a response to a service request (a request) received from the activation-requesting terminal 200. The core functions to be implemented by the core module 110 operate on a processor (CPU), for example. Once while in the halt mode, the core module 110 receives the activation instruction, the core module 100 is activated, and is switched from the halt mode to the operational mode.

The communications module 120 is switchable between the halt mode and the operational mode. While in the operational mode, the communications module 120 provides the network function to the core module 110. For example, the communications module 120 sends delivery data on the video content, which the communications module 120 receives from the core module 110, to the activation-requesting terminal 200 via the communications network 400. Once the communications module 120 receives the activation instruction, the communications module 120 is activated, and is switched from the halt mode to the operational mode. After switched to the operational mode, the communications module 120 sends the activation-requesting terminal 200 a reception completion signal for informing the activation-requesting terminal 200 of its reception of the activation signal. In this respect, the reception completion signal may be any signal that enables the activation-requesting terminal 200 to check the reception of the activation signal by the activation-target terminal 100. For example, the reception completion signal may at least include information for identifying the address of the activation-target terminal 100. For example, the activation-requesting terminal 100 can recognize that the destination terminal of the activation signal is already enabled to at least send the reception completion signal, by checking that the address to which the activation-requesting terminal 100 has sent the activation signal agrees with the information for identifying the address included in the received reception completion signal. In other words, the activation-requesting terminal 100 can check that the terminal to which the activation signal has been sent has rightly received the activation signal. The time needed for the communications module 120 to switch to the operational mode after receiving the activation instruction is shorter than that of the core module 110. That is because the core module 110 has a larger number of functions and uses higher spec hardware than the communications module 120. For example, the core module 110 is implemented on the CPU (Central Processing Unit) for the purpose of implementing the large-scale operating system for implementing the core functions, whereas the communications module 120 is implemented on a network interface card or the like. Incidentally, the devices on which the core module 110 and the communications module 120 are implemented are not limited to the CPU and the network interface card, respectively. At least, the core module 120 is implemented by use of any of a wide variety of hardware or software resources than the communications module 110.

Descriptions will be hereinbelow provided for a more concrete configuration of the activation-target terminal 100 on the basis of FIG. 2.

The activation-target terminal 100 includes the three modules 110, 120, 130.

Upon reception of the activation signal, the activation module 130 is prompted by the reception of the activation signal to issue the activation instruction to the communication module 120 and the core module 110. The activation module 130 is in an operational mode, even if the communications module 120 and the core module 110 are in their respective halt modes. To put it more specifically, for example, all of the activation-signal receiving I/F portion 131, the activation instructing portion 132 and a power supply manager 133 are always in the operational mode.

The communications module 120 makes communications with the activation-requesting terminal 200 by use of the communications network 400. The communications module 120 is switchable between the operational mode and the halt mode. Upon reception of the activation instruction while in the halt mode, the communications module 120 starts its activation, and switches from the halt mode to the operational mode. Once the communications module 120 switches to the operational mode, the communications module 120 sends the reception completion signal to the activation-requesting terminal 200. The time needed for the communications module 120 to switch to the operational mode after receiving the activation instruction is shorter than that of the core module 100. In this respect, the operational mode of the communications module 120 is defined as the one in which all the components (a communications I/F portion 121, a protocol processor portion 122, a message holder portion 123, a controller 124, an activation controller 125 and a power supply portion 126 which will be described later) of the communications module 120 are operational. The halt mode of the communications module 120 is defined as the one in which all the components of the communications module 120, except for the activation controller 125 and the power supply portion 126, are in a halt. However, the operational mode and the halt mode are not limited to these respective aspects. The operational mode can serve the purpose as long as the communications module 120 is at least ready to send the reception completion signal. In addition, the halt mode can serve the purpose as long as the power consumption is lower in the halt mode than in the operational mode. For example, the halt mode can serve the purpose as long as more of the components are in a halt in the halt mode than in the operational mode.

Upon reception of the activation instruction, the core module 110 starts its activation, and switches from the halt mode to the operational mode. In this respect, the operational mode of the core module 110 is defined as the one in which all the components (a core functioning portion 111, a communications administrator portion 112, a controller 113, an activation controller 114 and a power supply portion 115) of the core module 110 are operational. On the other hand, the halt mode of the core module 110 is defined as the one in which all the component of the core module 110, except for the activation controller 114 and the power supply portion 115, are in a halt. However, the operational mode and the halt mode are not limited to these ones. The operational mode, can serve the purpose as long as the core module 110 is ready to provide the core functions for the network service offered by the activation-target terminal 100 offers. In addition, the halt mode is defined as the one in which the power consumption is smaller in the halt mode than in the operational mode. For example, the halt mode can serve the purpose as long as more of the components are in a halt in the halt mode than in the operational mode.

Next, more detailed descriptions will be provided for each module.

The activation module 130 includes the activation-signal receiving I/F portion 131, the activation instructing portion 132 and the power supply manager portion 133.

The activation-signal receiving I/F portion 131 is configured to receive the activation signal sent to the activation-target terminal 100 from the activation-requesting terminal 200 via the activation-signal network 300. Upon reception of the activation signal, the activation-signal receiving I/F portion 131 informs the activation instructing portion 132 of the reception of the activation signal.

The power supply manager 133 manages the power supply to the activation-target terminal 100 as a whole. The power supply manager 133 controls ON and OFF of the power supply to the communications module 120 and the core module 110. For example, upon reception of the instruction from the activation instructing portion 132, the power supply manager 133 issues an instruction to the communications module 120 and the core module 110 in order to turn on the power supply of the communications module 120 and the core module 110. In this respect, the communications module 120 and the core module 110 are each configured to switch between two states: a state (a power ON state) in which the power supply is ON and a state (a power OFF state) in which the power supply is OFF. The communications module 120 and the core module 110 need to be in the power ON state in order for the power supply manager 133 to make the communications module 120 and the core module 110 switch to the operational mode.

Upon reception of the notice about the reception of the activation signal from the activation-signal receiving I/F portion 131, the activation instructing portion 132 issues the activation instruction to each of the core module 110 and the communications module 120.

The communications module 120 includes the communications I/F portion 121, the protocol processor portion 122, the power supply portion 126, the message holder portion 123, the activation controller 125, and the controller 124.

The communications I/F portion 121 is configured to send and receive data via the communications network 400.

The protocol processor portion 122 processes the protocol for sending and receiving the data by use of the communications I/F portion 121.

The power supply portion 126 is configured to manage the power supply of the communications module 120. The power supply portion 126 may control the power supply in accordance with the instruction from the power supply manager 133.

The message holder portion 123 holds information on the reception completion signal (referred to as “first information” in claim 3). Because the message holder portion 123 holds the information on the reception completion signal, the generation of the reception completion signal accordingly can be omitted from the communications module 120. For example, in a case where the message holder portion 123 holds the very reception completion signal as the information on the reception completion signal, it suffices that the communications module 120 sends the very information which is held by the message holder portion 123. Incidentally, the information on the reception completion signal may be information on part of the reception completion signal.

The information on the reception completion signal is for example, information on the address included in the activation signal. The information on the reception completion signal may be, for example, information on an address assigned to the communications I/F portion 121, for identifying the address of the activation-target terminal 100.

The information on the reception completion signal may include information on the time needed for the core module 110 to complete its activation (switch to the operational mode) after the beginning of the activation. The time needed for the core module 110 to complete its activation after the beginning of the activation may be an average of times needed in the past for the core module 110 to complete its activation after the beginning of the activation. In a case where the time needed for the core module 110 to complete its activation after the beginning of the activation is included in the reception completion signal to be sent to the activation-requesting terminal 200, the activation-requesting terminal 200 can know a rough estimate of the time needed for the core module 110 of the activation-target terminal 200 to complete its activation. As a result, the activation-requesting terminal 200 can know when the activation-requesting terminal 200 will be able to start to receive the service from the core module 110. Incidentally, the information on the reception completion signal may represent: anyone of the information on the address included in the activation signal, the information on the address assigned to the communications I/F portion 121, and the information on the time needed for the core module 110 to complete its activation after the beginning of the activation; or their combination.

In response to the instruction from the activation instructing portion 132, the activation controller 125 activates the communications module 120.

The controller 124 is configured to control the overall communications module 120. The controller 124 may be configured to control the connection between the communications module 120 and the core module 110.

The core module 110 includes the core functioning portion 111, the power supply portion 115, the communications administrator portion 112, the controller 113 and the activation controller 114.

The core functioning portion 111 includes a function of carrying out the main network service offered by the activation-target terminal 100.

The power supply portion 115 is configured to control the power supply of the core module 110. The power supply portion 115 may be configured to control the power supply in accordance with the instruction from the power supply manager 133 of the activation module 130. The power supply portion 115 controls the ON/OFF of the power supply of the overall core module 110, and switches the core module 110 between the power ON state and the power OFF state.

The activation controller 114 activates the core module 110 in response to the instruction from the activation instructing portion 132, and switches the core module 110 from the halt mode to the operational mode.

The communications administrator portion 112 provides the network function needed for the core module 110 to implement the core functions by controlling the modes and functions of the communications module 320.

The controller 113 controls the overall core module 110. The controller may be configured to control the connection between the core module 110 and the communications module 120.

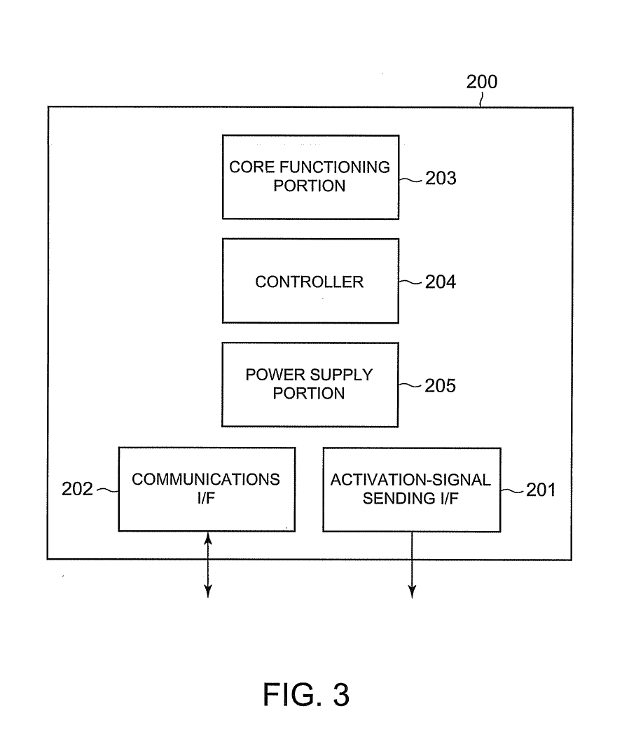

FIG. 3 is a block diagram showing a configuration of the activation-requesting terminal 200.

Descriptions will be provided for the activation-requesting terminal 200. The activation-requesting terminal 200 includes an activation-signal sending I/F 201, a communications I/F 202, a core functioning portion 203, a controller 204 and a power supply portion 205.

The activation-signal sending I/F 201 is configured to send the activation signal to the activation-target terminal 100 via the activation-signal network 300. Incidentally, the address of the activation-target terminal 100, which is the destination of the activation signal, is specified by the core functioning portion 203 or the communications I/F 202, for example.

The communications I/F 202 is configured to send and receive data via the communications network 400.

The core functioning portion 203 is in charge of the main function of the activation-requesting terminal 200. The main function of the activation-requesting terminal 200, which is provided by the core functioning portion 203, is the video displaying in a case where the activation-requesting terminal 200 is a display terminal.

The controller 204 controls the overall activation-requesting terminal 200.

The power supply portion 205 manages the power supply of the activation-requesting terminal 200.

Next, descriptions will be provided for operational procedures of the activation-target terminal 100 and the activation-requesting terminal 200.

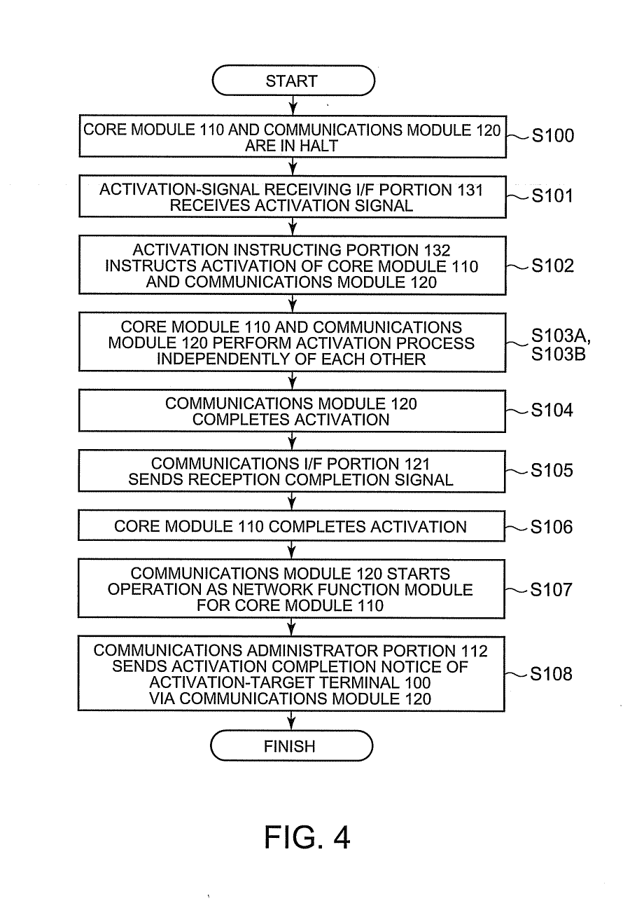

FIG. 4 is a flowchart showing how the activation-target terminal 100 operates.

First of all, descriptions will be provided for the initial state. While in the initial state, the core module 110 and the communications module 120 put their operation in a halt (in step S100). While in the initial state, the core module 110 and the communications module 120 may be in the power ON state, or in the power OFF state.

While in the initial state, at least the activation-signal receiving I/F portion 131 in the activation module 130 is ready to receive the activation signal whose address is the activation-signal receiving I/F portion 131. In addition, the message holder portion 123 stores in advance the information on the reception completion signal to be sent when the communications module 120 independently completes its activation (which may be the very reception completion signal, or information on part of the reception completion signal). No specific restriction is imposed on the content of the reception completion signal. Furthermore, the information on the receptions completion signal may be set at the time of the initialization or activation automatically or manually by the user.

The activation-target terminal 100 receives the activation signal whose address is the activation-requesting terminal 100 (for example, the ID for identifying the activation module 130) by use of the activation-signal receiving I/F portion 131 (in step S101). At least the address of the activation-target terminal 100 (for example, the ID for identifying the activation module 130) is included in the activation signal. Accordingly, upon reception of the activation signal, the activation-signal receiving I/F portion 131 informs the activation instructing portion 132 of the reception of the activation signal.

Once the activation-target terminal 100 receives the activation signal, the activation instructing portion 132 issues the activation instruction to the activation controller 125 of the communications module 120, and to the activation controller 114 of the core module 110 (in step S102). Incidentally, the activation instructing portion 132 may issue the activation instruction to the communications module 120 and the core module 110 at the same timing or at different timings.

Once the activation-target terminal 100 receives the activation signal, the activation instructing portion 132 may be configured to: inform the power supply manager 133 of the reception of the activation signal; controls the power supply portion 126 of the communications module 120, and the power supply portion 115 of the core module 110; and cause the power supply portions 126, 115 to start the power supply to the communications module 120 and the core module 110, respectively. The power supply to the communications module 120 and the core module 110 may be started at the same timing or at different timings. Alternatively, the power supply may be started to both the communications module 120 and the core module 110. Otherwise, the power may be supplied to either the communications module 120 or the core module 110.

Upon the reception of the activation instruction, the activation controller 125 of the communications module 120 starts the process for activating the overall communications module 120 (in step 103A). While making the controller 124 control the overall the communications module 120, the communications module 120 completes its activation, inclusive of the setting of the communications I/F portion 121, separately from the core module 110.

The activation controller 114 of the core module 110, which receives the activation signal at the same time as the activation controller 125, starts the process for activating the overall core module 110 in parallel to the activation process of the communications module 120 (in step 103B).

As described above, the period of time needed for the communications module 120 to complete its activation after the beginning of the activation is shorter than that of the core module 110.

It should be noted that the core module 110 does not have to carry out its activation process at the same time as the communications module 120. The core module 110 may carry out its activation process at a timing different from that at which the communications module 120 carries out its activation process.

Once the communications module 120 completes the activation process (switches to the operational mode) (in step S104), the communications I/F portion 121 sends the reception completion signal (in step S105).

A method of generating the reception completion signal can be implemented by making the communications I/F portion 121 generate the reception completion signal by use of the whole or part of the information held in the message holder portion 123.

It should be noted that the reception completion signal does not have to be generated by use of the information held in the message holder portion 123. The communications module 120 may generate the entirety of the reception completion signal after the completion of the activation, or during the activation. The communications module 120 may generate the reception completion signal by use of only the information included in the activation instruction. Otherwise, the communications module 120 may generate the reception completion signal by use of its own address which is the information included in the activation signal (for example, the ID for identifying the activation module 130). In this respect, a method of sending the reception completion signal may be any one of a broadcast, multicast and unicast. The address of the destination designated in the case of the multicast or unicast may be determined by use of any one of: the information held in the message holder portion 123; the address information included in, or noticed at the same time as, the activation instruction sent from the activation instructing portion 132 of the activation module 130 to the activation controller 125 of the communications module 120; and the address information noticed from the activation module 130 in some way not connected with the activation instruction.

Descriptions will be further provided for how to set up the SSID (Service Set Identifier) and WEP (Wired Equivalent Privacy) key which are needed to set up the wireless LAN interface in the case where the communications I/F portion 121 is the wireless LAN interface. The wireless LAN interface may be set up in the communications I/F portion 121 in advance, or may be set up automatically by use of the information held in the message holder portion 123 or the like during the activation process.

The wireless LAN channel may be set up in the communications I/F portion 121 in advance, or may be set up automatically by use of the information held in the message holder portion 123 or the like during the activation process. Otherwise, the setup of the wireless LAN channel may be fulfilled by: scanning channels right after the completion of the activation of the communications I/F portion 121; and setting up the wireless LAN channel by use of an appropriate one of the channels. In addition, all the channels may be scanned at the same time. Furthermore, optimization may be performed. In this respect, examples of the optimization include an arrangement in which: history information on things such as the channel of an access point which was connected at the time of the previous activation is stored in the message holder portion 123 or the like; and the channel is scanned at first by referring to the history information.

Any format/protocol form may be used for the reception completion signal. In the case of the wireless LAN, for example, the general practice is to send and receive data after establishing a process, which is termed as an “association,” between LAN access points. For this reason, a frame including the reception completion signal as data may be broadcast after the establishment of the association. Otherwise, the reception completion signal may be sent by the unicast to the wireless LAN access points to be found by the channel scanning.

Furthermore, the reception completion signal may be sent by being embedded in a CTS (Clear To Send) format, which is one of the ready-for-sending wireless LAN management frames, without performing the association establishing process in advance. In this case, the completion of the reception of the activation signal can be informed by eliminating the time needed for the association to be established.

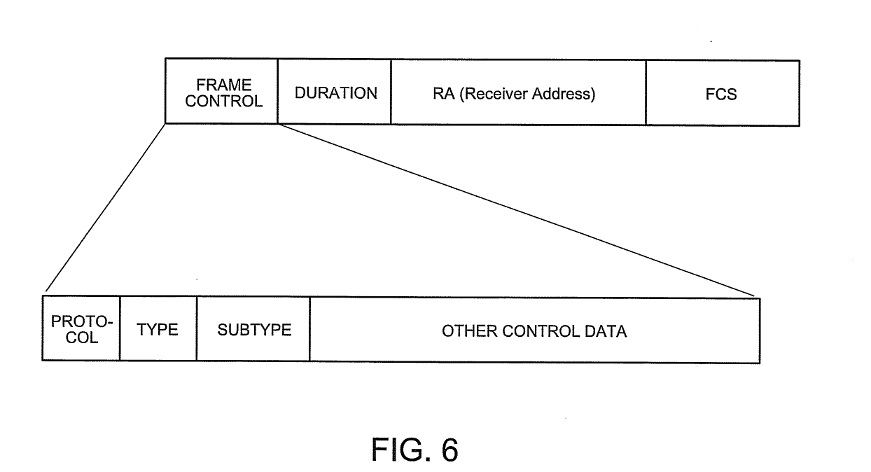

FIG. 6 is a diagram showing the CTS frame format. The CTS management frame can be obtained by setting 00 in the “protocol” section, 10 in the “type” section, and 0011 in the “subtype” section. Data corresponding to the reception completion signal may be inserted in the “other control data” section, in the “RA (Receiver Address)” section, or between the RA and FCS (Format Check Sequence) sections as the other data.

Moreover, the reception completion signal may be sent several times by combining the aforementioned various sending method.

Once the sending of the reception completion signal is finished, the controller 124 of the communications module 120 waits for the core module 110 to complete the activation.

Once the core module 110 completes the activation process (in step S106), the controller 113 of the core module 110 informs the controller 124 of the communications module 120 of the completion of the activation of the core module 110.

Once the controller 124 of the communications module 120 recognizes the completion of the activation of the core module 100, the controller 124 stops the mode in which the communications module 120 operates independently. Thereafter, the communications module 120 starts an operation as a network function module which is connected to and used by the core module 110 (in step S107). The controller 113 of the core module 110 recognizes that the communications module 120 has started to operate as the network function module which can be used by the controller 113 through the connection. Thereafter, the communications administrator portion 112 of the core module 110 is connected to the communications module 120 operating as the network function module, and reinitializes the communications module 120 if necessary. Subsequently, the communications module 120 operates as the network function module which can be assessed by the core functioning portion 111 of the core module 110. This operation is hidden from the core functioning portion 111 of the core module 110, and does not affect the operation of the applications which run on the core functioning portion 111.

Once the core module 110 completes its activation, the communications administrator portion 112 of the core module 110 may be configured to send an activation completion notice, which shows the completion of the activation of the activation-target terminal 100, to the activation-requesting terminal 200 via the communications module 120 (in step S108).

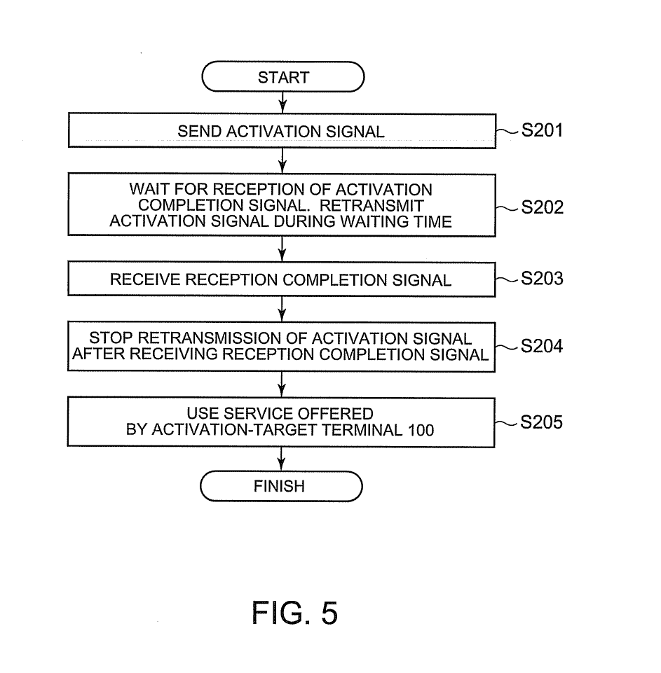

Next, descriptions will be provided for the sequence in which the activation-requesting terminal 200 operates. FIG. 5 is a flowchart showing how the activation-requesting terminal 200 operates.

The activation-requesting terminal 200 is requested to activate the activation-target terminal 100 which is performing the core function. The activation-requesting terminal 200 sends the activation signal from the activation-signal sending I/F 201 to the destination which is the address of the target activation-target terminal 100 (in step S201). The activation signal includes at least the address of the activation-target terminal 100. Incidentally, the descriptions of the operation imposes no specific restriction on things such as means for identifying the address of the activation-target terminal 100, the relationship between the communications I/F and the address of the activation-target terminal 100.

The activation-requesting terminal 200 waits for the communications I/F 202 to receive the activation completion signal which includes the address of the activation-target terminal 100 as the destination to which the activation signal has been sent (in step S202). Depending on the necessity, the activation-requesting terminal 200 may be configured to send the activation signal repeatedly at certain intervals until the activation-requesting terminal 200 finishes receiving the reception completing signal.

Upon the reception of the reception completion signal from the activation-target terminal 100 (in step S203), the activation-requesting terminal 200 completes the operation of sending the activation signal repeatedly if the activation-requesting terminal 200 is in the process of carrying out the operation (in step S204). The activation-requesting terminal 200 is capable of detecting the reception of the activation signal by the activation-target terminal 100, for example, from the address of the activation-target terminal 100 which is included in the reception completion signal. The activation-requesting terminal 200 starts the operation of the core functioning portion 203 or the operation of the communications I/F 202 for using the network service offered by the activation-target terminal 100 (in step S205). After that, the activation-requesting terminal 200 requests the network service from the activation-target terminal 100.

It should be noted that the activation-requesting terminal 200 may be configured to start the operation in step S204 right after receiving the activation completion notice from the activation-target terminal 100.

The descriptions of how the activation-requesting terminal 200 operates ends with this.

At least the foregoing embodiment enables the activation-requesting terminal 200 to quickly recognize that the activation signal has been rightly received by the activation-target terminal 100. This makes it possible to prevent the activation-requesting terminal 200 from doing things such as the unnecessary repeated sending of the activation signal, and accordingly to make the activation-requesting terminal 200 operate more efficiently and save energy.

In this embodiment, the communications module 120 is configured to operate as the network function module connected to and used by the core module 110, after the completion of the activation of the core module. It should be noted, however, that the communications module 120 does not have to operate as the network function module connected to and used by the core module 110. In this case, the network function module connected to and used by the core module 100 may be provided to the activation-target terminal 100.

In addition, the activation-requesting terminal 200 and the activation-target terminal 100 may be of any type. For example, the activation-requesting terminal 200 may be a household energy management server, and the activation-target terminal 100 may be a television set. In this case, the embodiment can be used in a way that when the household energy management server intends to display a message for the user on the television display, the household energy management server activates the television set by sending the activation signal to the television set and causes the television set to display the message on the television display.

In addition, the foregoing descriptions have been provided for the case where: the activation module 130 is configured to be identified by use of the single ID; and accordingly, the number of core module 110 is one. However, the embodiment is not limited to this case. For example, the activation module 130 may be configured to be identified by use of any of multiple IDs. To meet this modification, multiple core modules 110 may be provided. In such a case, the activation module 130 is capable of changing the core module to which the activation instruction is issued depending on an ID received. Otherwise, the activation module 130 may be configured to simply change information, which is included in the activation instruction, depending on the type of the ID by which the activation module 130 is identified. In addition, the activation instruction may include all of the received IDs. In this case, each of the multiple core modules 110 may be configured to have a function of determining whether to activate itself depending on the IDs included in the received activation instruction.

Furthermore, the activation-target terminal 200 can be implemented, for example, by using a general-purpose computer as basic hardware. To put it specifically, the core module 110 (the core functioning portion 111, the communications administrator portion 112, the controller 113, the activation controller 114 and the power supply portion 115), the communications module 120 (the communications I/F portion 121, the protocol processor portion 122, the message holder portion 123, the controller 124, the activation controller 125 and the power supply portion 126), and the activation module 130 (the activation-signal receiving I/F portion 131, the activation instructing portion 132 and the power supply portion 133) can be implemented by causing the processor installed in the computer to execute a program. In this process, the activation-target terminal 200 may be implemented by installing the program in the computer in advance. Otherwise, the activation-target terminal 200 may be implemented by: distributing the program in the form of a storage medium such as a CD-ROM in which the program are stored, or via the network; and installing the program in the computer depending on the necessity. Moreover, the message holder portion 123 can be implemented by using a storage medium, such as a memory, hard disc, CD-R, CD-RW, DVD-RAM or DVD-R, which is built in or externally attached to the computer, depending on the necessity.

The present invention is not limited to the embodiments stated so far but can be carried out by modifying the constituent elements without departure from the scope of the present invention in a working phase. Moreover, various inventions can be created by appropriate combinations of a plurality of constituent elements disclosed in the embodiments stated so far. For example, some of the constituent elements can be deleted from the overall constituent elements shown in the embodiments. Besides, the constituent elements in the different embodiments can be appropriately combined.

The process program(s) according to this embodiment may be provided after being recorded on a computer readable recording medium, such as a CD-ROM (Compact Disk Read Only Memory), flexible disk (FD), CD-R (Compact Disk Recordable), DVD (Digital Versatile Disk), in the form of an installable format file or executable format file.

The process program(s) according to this embodiment may be stored on a computer connected to a network, such as the Internet, and may be downloaded through the network so as to be provided. The process program(s) according to this embodiment may be provided or delivered through a network, such as the Internet.

The process program(s) of this embodiment may be incorporated in the ROM or the like so as to be provided.

What is claimed is:

1. A communications terminal comprising:
a receiver portion to receive an activation signal from an activation-requesting terminal;
a communications module to send a reception completion signal to the activation-requesting terminal;
a core module to provide a core function; and
an activation instructing portion to instruct an activation instruction to the communications module and the core module, when the receiver portion receives the activation signal,
wherein
upon reception of the activation instruction while in a halt mode, the core module switches from the halt mode to an operational mode,
upon reception of the activation instruction while in a halt mode, the communications module switches from the halt mode to an operational mode, and sends the reception completion signal after switching to the operational mode, and
a period of time needed for the communications module to switch to the operational mode after receiving the activation signal is shorter than that of the core module.

2. The terminal of claim 1,
wherein the reception completion signal includes an address assigned to the communication terminal.

3. The terminal of claim 1 further comprising,
a message holder portion to hold first information on the reception completion signal,
wherein the communications module sends the reception completion signal generated by the first information.

4. The terminal of claim 1,
wherein while in the halt mode, the communications module and the core module switches between a power ON state and a power OFF state, and
the activation instructing portion instructs the core module and the communications module to switch from the power OFF state to the power ON state.

5. The terminal of claim 1,
wherein after the core module switches to the operational mode, the communications module provides a network function for the core module.

6. The terminal of claim 5,
wherein the core module has a function for responding to a request, which is received from the activation-requesting terminal, using the network function of the communications module.

7. The terminal of claim 6,
wherein the communications module sends the reception completion signal which includes the address included in the activation signal.

8. The terminal of claim 7,
wherein the first information held in the message holder portion includes information on an address assigned to an interface of the communications module.

9. The terminal of claim 8,
wherein the communications module uses a wireless LAN management frame to send the reception completion signal.

10. The terminal of claim 9,
wherein the first information held in the message holder portion is information on a time needed for the core module to switch to the operational mode after the beginning of the activation.

11. A computer readable medium storing a communications program comprising:
a receiver function to receive an activation signal from an activation-requesting terminal;
a communications module function to send a reception completion signal to the activation-requesting terminal;
a core module function to provide a core function; and
an activation instructing function to instruct an activation instruction to the communications module function and the core module function, when the receiver function receives the activation signal,
wherein
upon reception of the activation instruction while in a halt mode, the core module function switches from the halt mode to an operational mode,
upon reception of the activation instruction while in a halt mode, the communications module function switches from the halt mode to an operational mode, and sends the reception completion signal after switching to the operational mode, and
a period of time needed for the communications module function to switch to the operational mode after receiving the activation signal is shorter than that of the core module function.

12. The computer readable medium storing a communications program according to claim 11,
wherein the reception completion signal includes an address assigned to a communication terminal.

13. The computer readable medium storing a communications program according to claim 11 further comprising,
a message holder function to hold first information on the reception completion signal,
wherein the communications module function sends the reception completion signal generated by the first information.

14. The computer readable medium storing a communications program according to claim 13,
wherein while in the halt mode, the communications module function and the core module function switches between a power ON state and a power OFF state, and
the activation instructing function instructs the core module function and the communications module function to switch from the power OFF state to the power ON state.

15. The computer readable medium storing a communications program according to claim 11,
wherein after the core module function switches to the operational mode, the communications module function provides a network function for the core module.

16. The computer readable medium storing a communications program according to claim 15,
wherein the core module function has a function for responding to a request, which is received from the activation-requesting terminal, using the network function of the communications module function.

17. The computer readable medium storing a communications program according to claim 16,
wherein the communications module function sends the reception completion signal which includes the address included in the activation signal.

18. The computer readable medium storing a communications program according to claim 17,
wherein the first information held in the message holder function includes information on an address assigned to an interface of the communications module function.

19. The computer readable medium storing a communications program according to claim 18,
wherein the communications module function uses a wireless LAN management frame to send the reception completion signal.

20. The computer readable medium storing a communications program according to claim 19,
wherein the first information held in the message holder function is information on a time needed for the core module function to switch to the operational mode after the beginning of the activation.
